(19) United States
(12) Patent Application Publication
(10) Pub. No.: US 2006/0143566 A1
(43) Pub. Date: Jun. 29, 2006

(54) Recording medium, method for previewing on-demand digital multimedia data on the recording medium

(76) Inventors: Meng-Han Tsai, Taipei City (TW); Guo-Zua Wu, Taichung City (TW); Wei-Zheng Lu, Chiayi City (TW); Kun-Da Wu, Nantou City (TW); Jian-Ru Li, Chaojhou Township (TW)

Correspondence Address: LIN & ASSOCIATES INTELLECTUAL PROPERTY, P.O. BOX 2339, SARATOGA, CA, 95070-0339, US

(21) Appl. No.: 11/024,387

(22) Filed: Dec. 28, 2004

(51) Int. Cl. G11B 27/00; H04N 7/173

(52) U.S. Cl. 715/719

(57) ABSTRACT

A recording medium and a method for previewing and selecting digital audio/video data unit on the recording medium are provided. The recording medium includes an audio/video pack of the original film, an audio/video pack of the preview film, a background page, and a page control descriptor. After having received a switch button information from a user, a medium reproducing system reads, de-multiplexes, and decodes the information correspond to a specified audio/video pack of the preview film. The medium reproducing system also composes the decoded video data of the background page and the decoded video data of different resolutions to output to a display.

### FIELD OF THE INVENTION

The present invention generally relates to a recording medium and a method for previewing on-demand digital multimedia stored on said recording medium, and more specifically to a recording medium using a high density method for storing video and audio data and a previewing method for selecting audio video data stored on the recording medium.

### BACKGROUND OF THE INVENTION

The optical-electronic recording medium evolved from the early audio compact disc (CD), which is for audio only, to the audio/video recording medium, such as laser disc, video compact disc (VCD), and more recently, digital versatile disc (DVD) with selection menu.

In the earlier VCD, there is only one mode button, i.e., activated mode in the selection menu of a player because of the simple data structure of the recording medium. FIG. 1A shows a schematic view of the data structure of a VCD. An entry table 100 includes a plurality of entry points 101-10N, with each entry point having a corresponding track 111-11N. Track 111 further includes a plurality of video packs 111b, headed by an entry video pack 111a, and a plurality of audio packs 111c.

FIG. 1B shows a schematic view of a playing method of a VCD. A reproducing system first initializes an audio decoder and a single-resolution video decoder, as in step 151. In step 152, an entry menu is loaded from a VCD in the reproducing system. In step 153, the reproducing system receives an activation signal from the user. Step 154 is to find an entry point, and step 155 is to move a reading device of the reproducing system to the entry point corresponding to the activation signal. In step 156, the reading device reads all the video packs and audio packs of the track corresponding to the entry point, and, in step 157, all the video and audio packs are decoded.

One of the shortcomings of VCD is that all of video sequence datas have the same output resolution; therefore, only a single-resolution background films can be played in the menu. Furthermore, the only button is the activation button; that is, the user can only activate and read the original audio/video data, and no previewing is allowed.

In the current DVD technologies, the menu function is improved. As DVD has a more complicated data structure than VCD, the menu of a reproducing system usually includes two modes, namely, a selected mode and an activated mode. The reproducing system reads, from the DVD, the button information and highlight information of the selection buttons and their corresponding sub-pictures. The button information and the highlight information are for the reproducing system to obtain the coordinates, color and activation commands of the selection buttons, and the sub-pictures are used as the icons of the buttons. When the reproducing system receives an external signal as a selection signal, the reproducing system places the sub-picture of the selected button according to the coordinates in the button information and highlight information over the background. When the reproducing system receives an external activation signal, it executes the activation command corresponding to the selected button.

FIG. 2 shows a data structure of a preview method of a DVD. Button information 202 of highlight information 201 includes a mode 203 and an activation command 204. Mode 203 includes two options. One is the selected mode plus activated mode, and the other is activated mode only. DVD can perform activation command 204 only in the activated mode; that is, to preview the N-th VOBU (video object unit), go to a starting address table 210 to read the starting address 21N of the N-th VOBU, and to read the audio/video data from starting address 21N. In this DVD technology, every VOBU of the title can only have a single resolution for all the audio/video data The reproducing system cannot process audio/video data with more than one resolution at the same time; therefore, the preview video sequence must be pasted to the background video sequence one picture by one picture during the production of the menu, and then encoded and stored to the DVD disc. However, the compressed data will include a large amount of background pages of information, which takes up a lot of storage space. In the current technology, the button and audio/video information are without links; therefore, no on-demand preview is allowed. U.S. Pat. No. 5,963,704, by Mimura in 1998, disclosed a menu system 304, as shown in FIG. 3, including a background dynamic video sequence 301, a sub-picture image 302, and highlight information 303. Sub-picture image 302 includes all the icons of the buttons, and highlight information records information of all the buttons. The reproducing system knows, through highlight information, the position of every button, and the command to be executed by every button in the activated mode.

When the user selects a button, the system enters the selection mode. The reproducing system continues to play the background video sequence, locates the information of the selected button through highlight information, and finally overlaps the icon of the selected button in the sub-picture image to the background video sequence in accordance with the button information. The aforementioned description shows that the menu system can only play a background dynamic video sequence with a fixed resolution, and can only have a selection mode and an activation mode. It cannot change the disc for playing under the selection mode; therefore, it does not provide the previewing mechanism of the disc.

U.S. Pat. No. 6,266,478, by Yoshiro in 1999, disclosed a reproducing system for displaying a subtitle image and a highlight display of the subtitle image. Using the video object unit (VOBU) as the unit for the data stored in the recording medium, each VOBU includes a navigation pack for recording highlight information. The reproducing system uses highlight information to obtain the button, playing position, color and play time of the subtitle image in the VOBU to play. The high light information contains only highlight information of the sub-picture image, and does not have the information on video sequence. Therefore, there is no link between the video sequence and the highlight information, and they are independent of each other. The system cannot change the video sequence in accordance with the user's selection, and does not provide the on-demand previewing.

At present, to resume the viewing of a DVD or VCD disc requires the playing-and-skipping of entire disc to locate the resumption point. It is a time-consuming process. With the previewing capacity, it will greatly reduce the amount of time to locate and resume the viewing of a disc.

### SUMMARY OF THE INVENTION

The present invention has been made to overcome the aforementioned drawback of current digital multimedia data viewing. The primary object of the present invention is to provide a preview method for a digital audio/video disc, and its recording medium.

The preview method is applicable to a medium information reproducing system. The medium information reproducing system includes a signal receiver, an audio output device and a display. The method includes the following steps: (a) Divide, encode and store data in a recording medium, so that the medium includes at least a preview audio/video data unit area, a background page area and a page control descriptor area. The preview audio/video data unit area includes a plurality of preview audio/video data units. The background page area stores the video data of the background page, and a plurality of buttons. The page control descriptor area stores the page control description data, and includes at least an area of total number of buttons, and a plurality of button information area. Each button information area stores button information, including at least a starting address of preview audio/video data unit, a set of coordinates for previewing window and a size of preview window. (b) Read, de-multiplex and decode the page control description data and the background page video data, and then output decoded background page video data to a display. (c) Detect an input switch button signal, and identify the corresponding button. (d) Read, de-multiplex and decode the audio/video data access unit in accordance with the starting address of the preview audio/video data unit of the button information. (e) Preview the preview audio/video data unit.

The present invention establishes links between each button and preview window and low-resolution audio/video data access unit, so that the digital audio/video data can be previewed on-demand.

According to the present invention, step (b) can further include the four sub-steps: (b1) Read, de-multiplex and decode the page control description data and the background page video data. (b2) Pre-set one of the buttons of the background page as the initial button. (b3) Read, de-multiplex and decode the audio/video data unit in accordance with the starting address of the preview audio/video data unit of the button information. (b4) Repeatedly play the preview audio/video data unit in the preview window corresponding to the button.

According to the present invention, step (c) can further include the following four sub-steps: (c1) Check if a switch button signal is received; if not, repeat step (c1). (c2) identify the switch button signal. (c3) Check if the button mode of the button information is preview-able; if not, go to step (c1). (c4) Read the starting and ending addresses of preview audio/video data unit, a set of coordinates for previewing window and a size of preview window.

According to the present invention, step (e) can further include the following four sub-steps: (e1) Overlap the video data of the decoded preview audio/video data unit onto the previewing window specified by the coordinates in the decoded background page video data, and output the overlapped video data to the display, while outputting the audio data of the decoded preview audio/video data access unit to an audio output device. (e2) Check if a switch button signal is received; if so, return to step (c2). (e3) Read, de-multiplex and decode a next preview audio/video data access unit. (e4) Determine if the reading has reached the ending address of the preview audio/video data access unit; if so, return to step (d); otherwise, return to step (e1).

Another objective of the present invention is to provide a recording medium to be used in a reproducing system so that the data stored in the recording medium can be played. The recording medium includes an original audio/video data unit packet, a preview audio/video data unit packet, a background page packet, and a page control descriptor packet. The original audio/video data packet includes a plurality of original audio data units and a plurality of original video data units. The preview audio/video data unit packet includes a plurality of preview audio data units and a plurality of preview video data units. The total amount of data of the preview audio/video data unit packet is about 205 of that of the original audio/video data unit packet. The background page packet stores the background page video data The page control descriptor packet stores at least a total number of the buttons and a plurality of button information. Each button information at least includes a button mode, a starting address of the original audio/video data unit, an ending address of the original audio/video data unit, a button coordinate, a button size, a previewing window coordinate, and previewing window size.

The present invention can processes video data of two different resolutions; therefore, it can reduce the amount of data stored on the recording medium.

The present invention includes a preview mode before the activated mode. When the button is in the preview mode, the reproducing system uses the links stored on the recording medium to process the low-resolution preview audio/video unit data and high-resolution background page when receiving a switch button signal from the user. The composite image is output in real-time.

Furthermore, the current technique used for DVD previewing is to paste the data in each preview audio/video data unit packet to the background page to form a new film, which is then compressed and stored in the DVD. The compressed data requires a large storage space because it contains the background page video data. The present invention requires a smaller storage space because it only stores the data in the preview audio/video data unit packet.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1A shows a schematic view of the data structure of a conventional VCD.

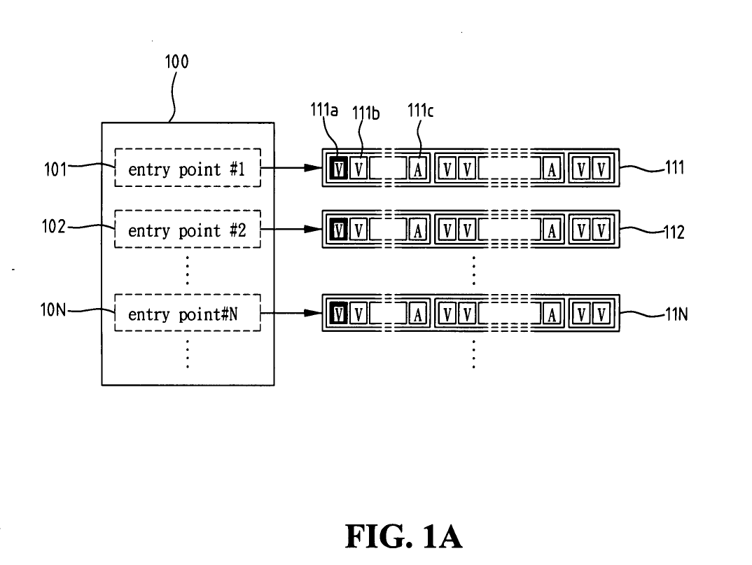

FIG. 1B shows a flowchart of reproducing method for digital audio/video film of a conventional VCD.

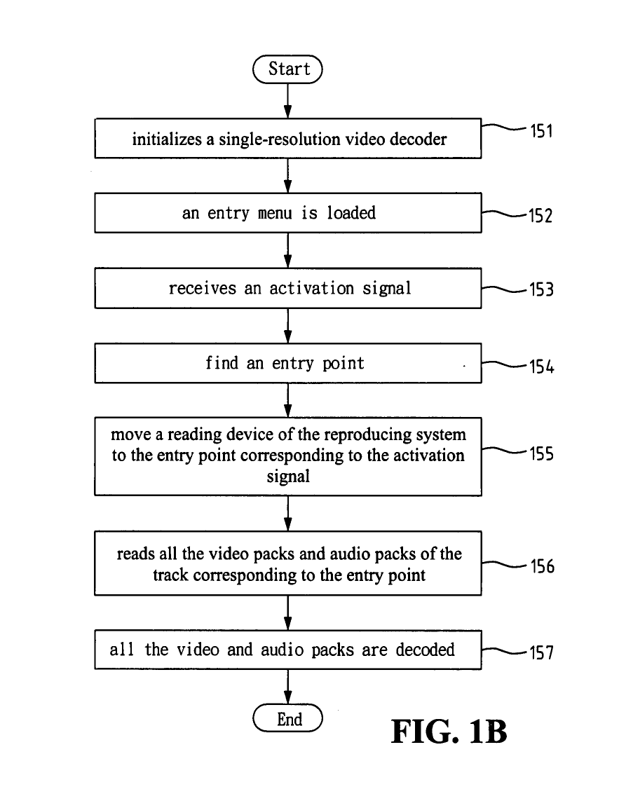

FIG. 2 shows a schematic view of the data structure of a conventional DVD.

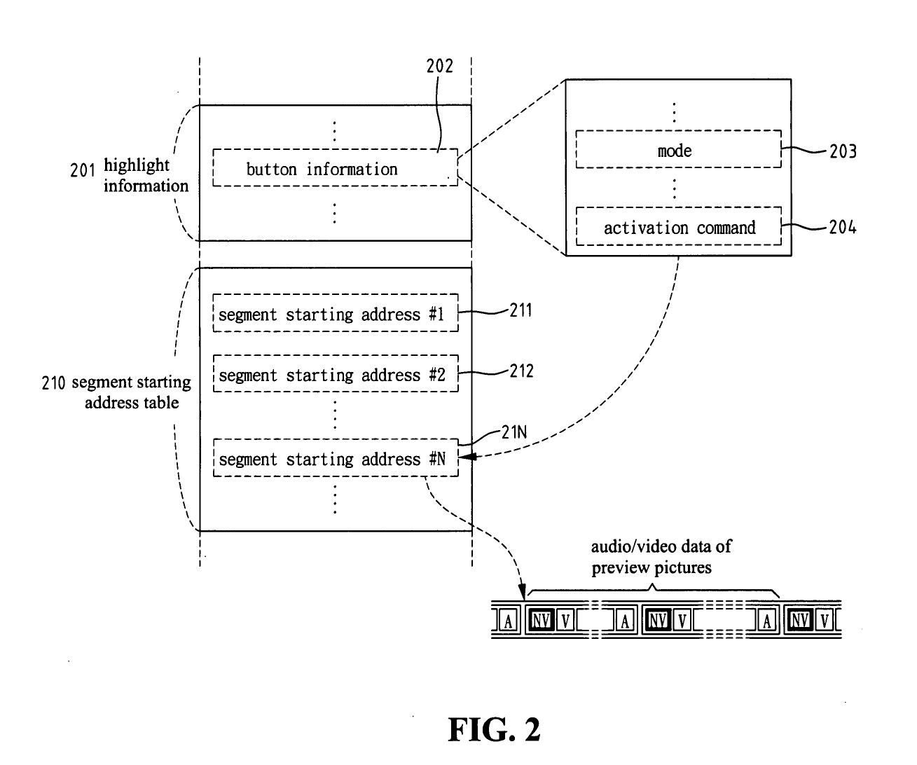

FIG. 3 shows a schematic view of a conventional menu system.

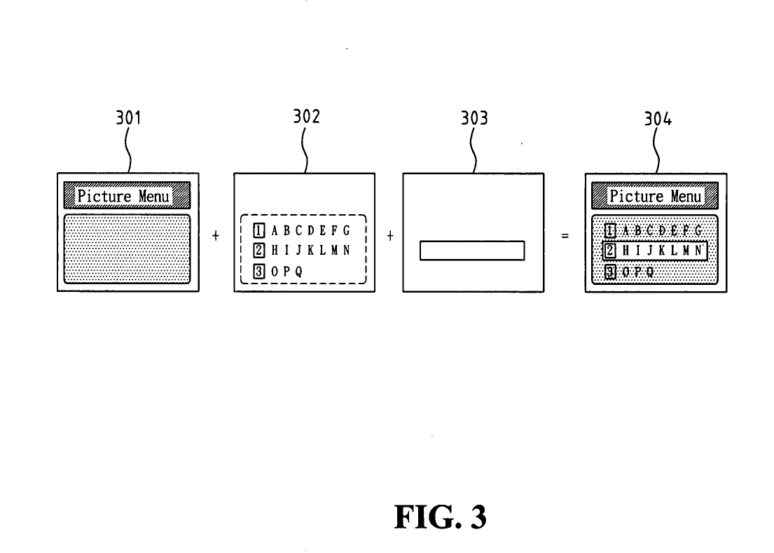

FIG. 4 shows a schematic view of the data structure of a recording medium of the present invention.

FIG. 5 shows a schematic view of the relationship between an original film and a preview film.

FIG. 6 shows a schematic view of the relationship between the recording medium of the present invention and a medium information reproducing system.

FIG. 7 shows a schematic view of the relationship between the menu page, preview audio/video data unit and original audio video data unit.

FIG. 8 shows a flowchart of the preview on-demand method for digital audio/video film.

FIG. 9A shows a flowchart of initialization method for the background page of the present invention.

FIG. 9B shows a flowchart of button detection method of the present invention.

FIG. 9C shows a flowchart of preview method for playing the preview audio/video data unit of the present invention.

### DETAILED DESCRIPTION OF THE PREFERRED EMBODIMENTS

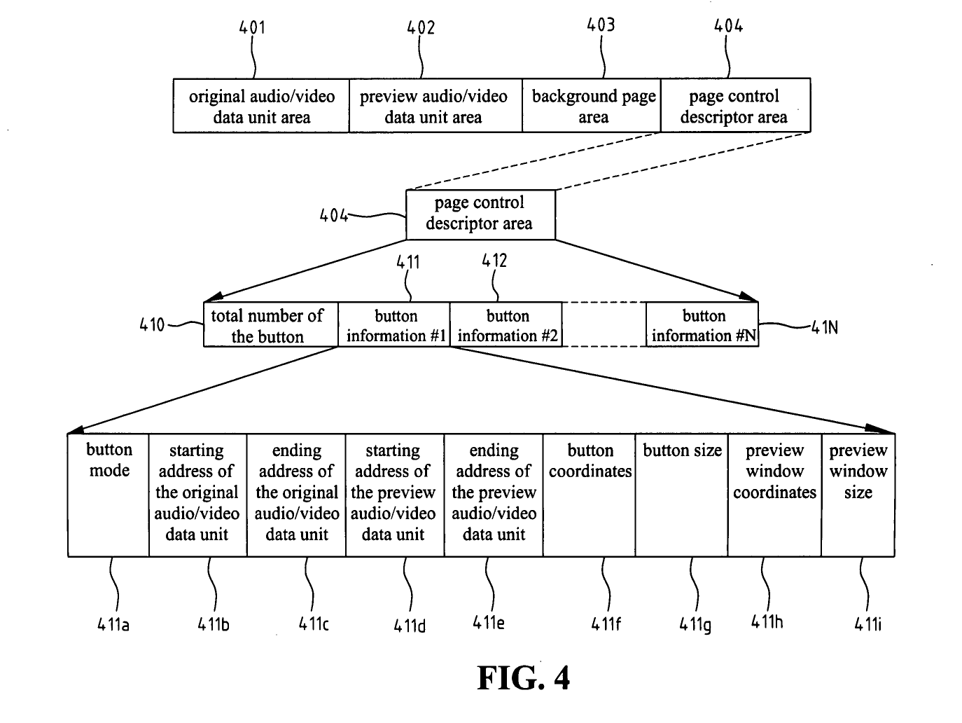

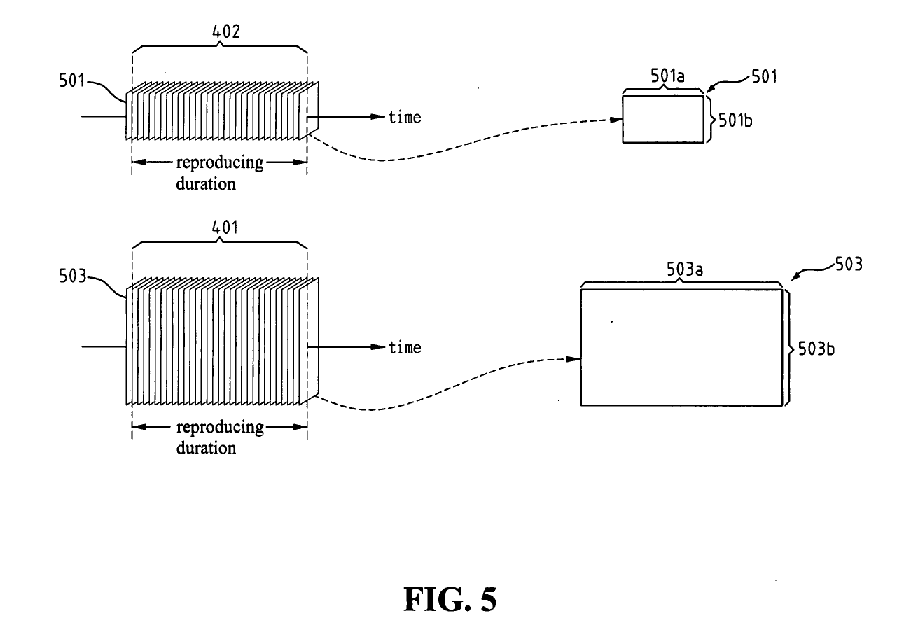

FIG. 4 shows a schematic view of the data structure of the recording medium of the present invention. FIG. 5 shows the relationship between the original film and the preview film in the present invention.

The following description refers to both FIG. 4 and FIG. 5. A recording medium 400 of the present invention, used in a medium reproducing system to play the data stored on the recording medium, includes an original audio/video data unit area 401, a preview audio/video data unit area 402, a background page area 403, and a page control descriptor area 404. Preview audio/video data unit area 402 includes a plurality of low-resolution preview audio/video data units 501. Original audio/video data unit area 401 includes a plurality of high-resolution original audio/video data units 503. The amount of data in preview audio/video data unit area 402 is about one-fifth of the amount of the data in original audio/video data unit area 401. Background page area 403 includes high-resolution background page video data. Page control descriptor area 404 stores page control description data, which includes at least a total number 410 of the buttons and a plurality of button information 4411-41N. Each button information 411-41N stores a button mode 411a, a starting address 411b of the original audio/video data unit, an ending address 411c of the original audio/video data unit, a starting address 411d of the preview audio/video data unit, an ending address 411e of the preview audio/video data unit, button coordinates 411f, a button size 411g, preview window coordinates 411h and preview window size 411i.

Button mode 411a is used to indicate if this button can enter the preview mode. Starting address 411b and ending address 411c of the original audio/video data unit are the starting and the ending points of the original audio/video data unit on the optical medium for the reproducing system to read when the button is in the activate mode. Starting address 411d and ending address 411e of the preview audio/video data unit are the starting and the ending points of the preview audio/video data unit on the optical medium for the reproducing system to read when the button is in the preview mode. Button coordinates 411f and button size 411g are the starting coordinates of the button in the background page and the size of the button, respectively. Similarly, window coordinates 411h and window size 411g are the starting coordinates of the preview window in the background page and the size of the preview window, respectively.

The distinct feature of the data structure of the present invention is that links are provided between each button, preview window and low-resolution audio/video data unit, so that the on-demand preview functionality can be achieved.

FIG. 5 shows a schematic view of the relationship between an original film and a preview film. Width 501a of the preview audio/video data unit 402 is less than or equal to width 503a of the original audio/video data unit 401, and length 501b of the preview audio/video data unit 402 is less than or equal to length 503b of the original audio/video data unit 401. Therefore, reproducing duration of the preview audio/video data unit 402 is less than or equal to reproducing duration of the original audio/video data unit 401. In addition, because the width and length of the background page are the same as those of the original audio/video data unit 401, width 501a and length 501b of the preview audio/video data unit 402 are less than or equal to the width and length of the background page, respectively.

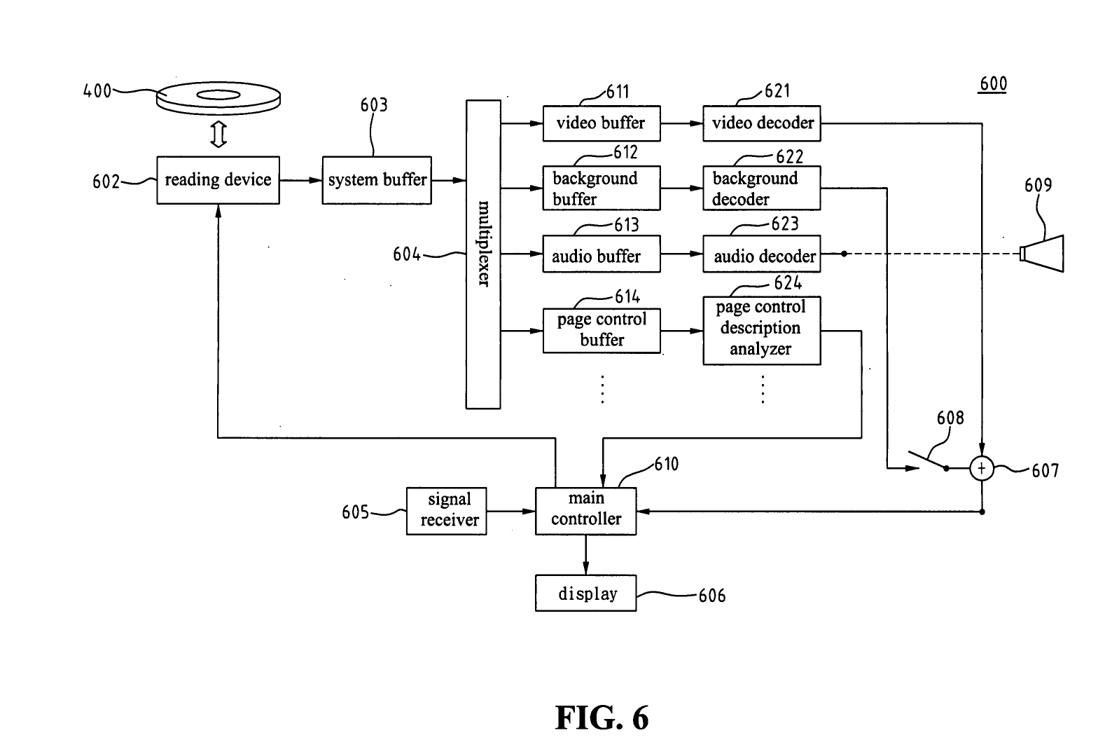

FIG. 6 shows a schematic view of the relation between a recording medium 400 of the present invention and a medium reproducing system 600. Medium reproducing system 600 uses a reading device 602 to read the data on recording medium 400 into a system buffer 603. Medium reproducing system 400 then uses a multiplexer 604 to separate different types of data into separate buffers. That is, the video data is stored in video buffer 611 and audio data is stored in audio buffer 613, while background page video data is stored in background buffer 612 and page control description data is stored in page control buffer 614. The system inputs the video data, audio data, background video data and the page control description data to video decoder 621, background decoder 622, audio decoder 623 and page control description analyzer 624 for processing. There are two sources for audio and video data, including low-resolution preview audio/video data unit 501 and high-resolution original audio/video data unit 503. The page control description data is interpreted by page control analyzer 624.

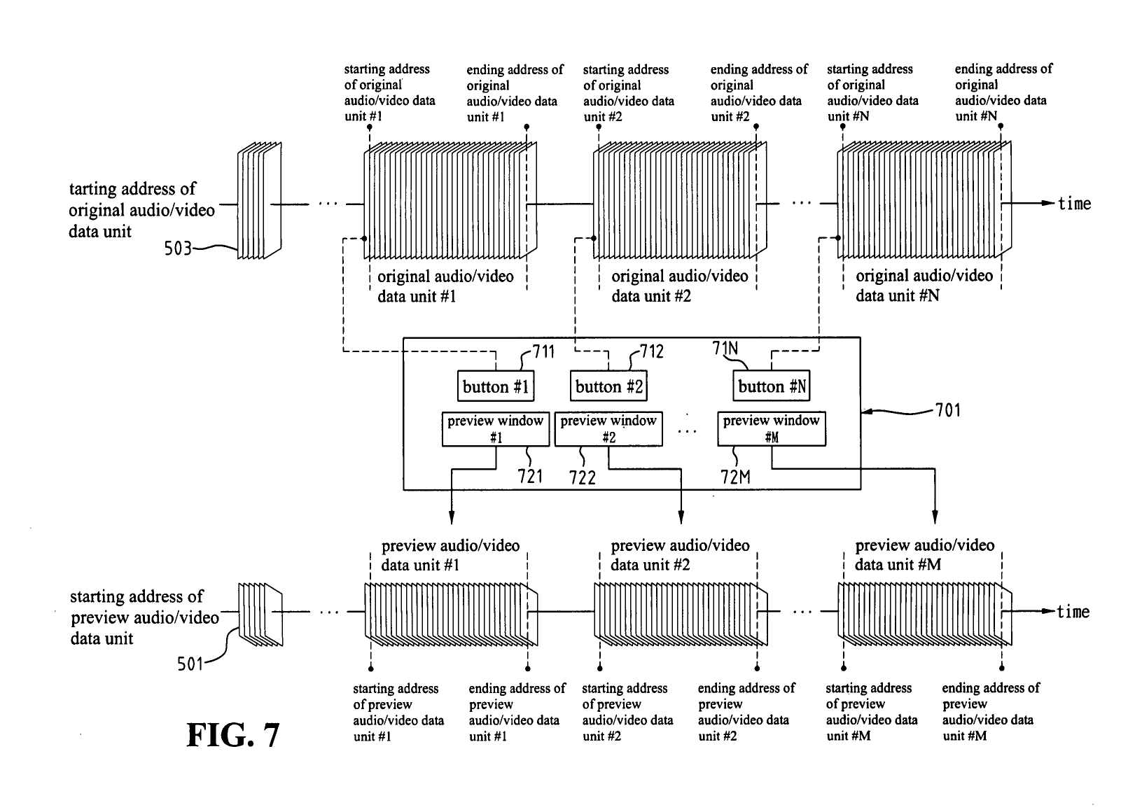

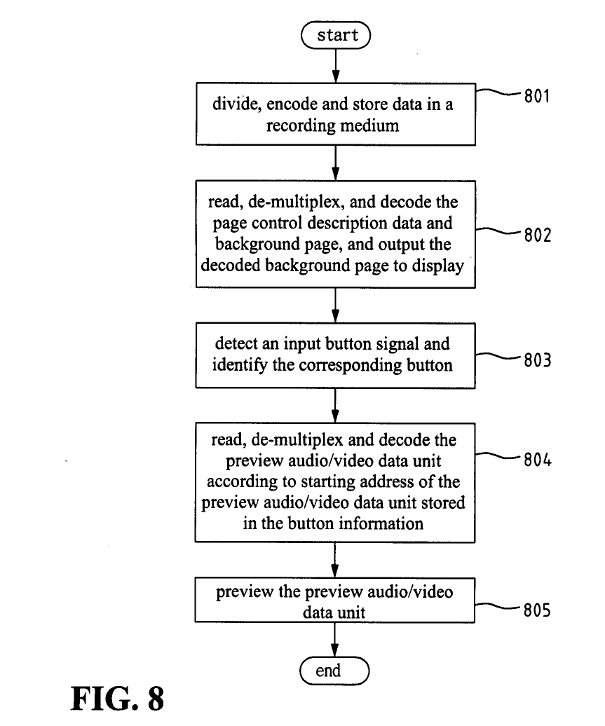

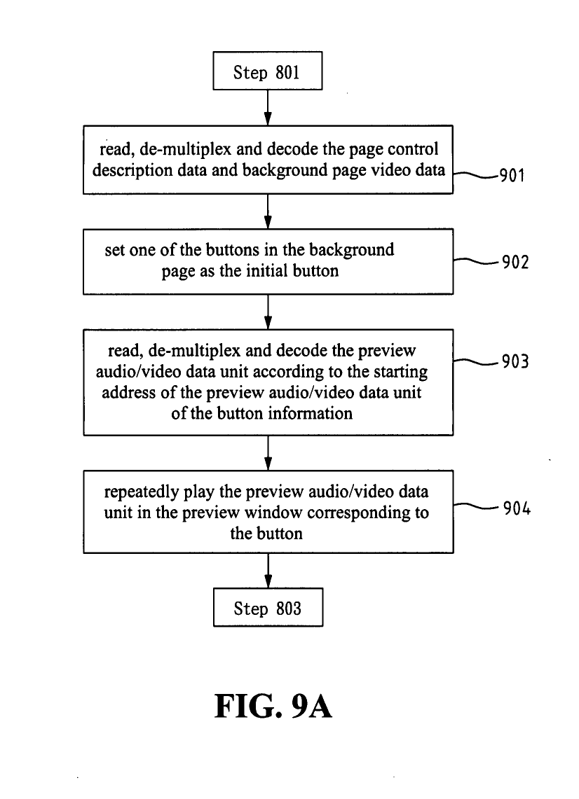

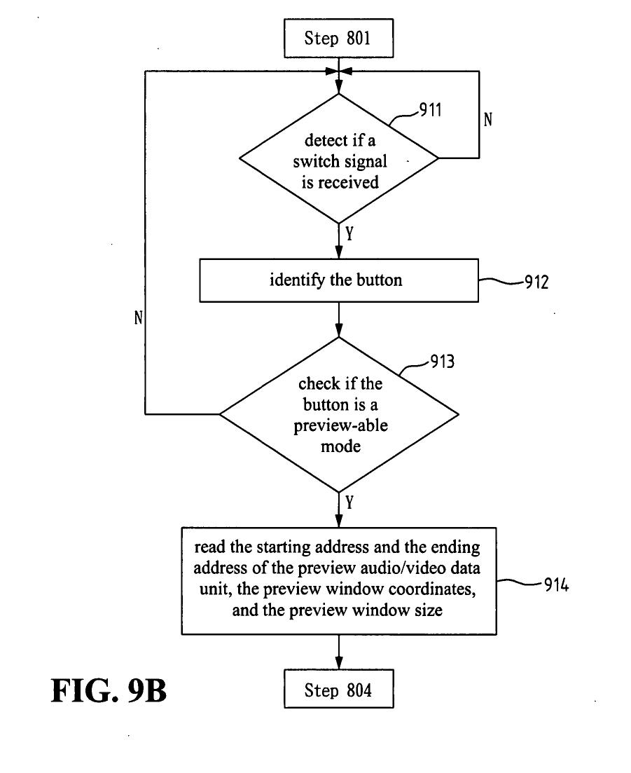

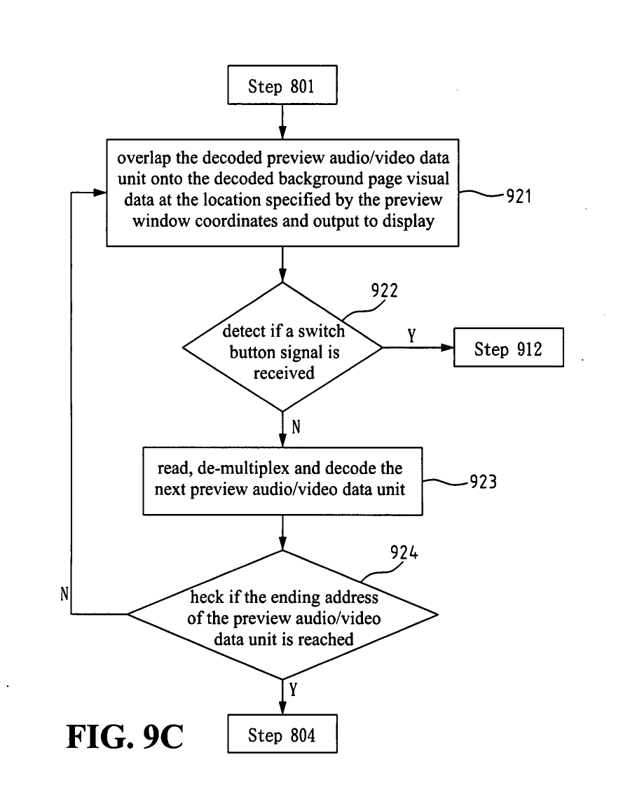

FIG. 7 shows a schematic view of the relation between the menu, preview audio/video data unit and original audio/video data unit of the present invention. As shown in FIG. 7, menu of the present invention includes a background page 701, a plurality of buttons 711-71N, and a plurality of preview windows 721-72M. The preview audio/video data unit is divided into M VOBUs for playing. The original audio/video data unit is divided into N VOBUs for playing. Refer to FIG. 6 and FIG. 7 for the following description. When the movement button (up, down, left, and right) on the remote control is pressed, main controller 610 enters the preview mode according to the page control description data and the switching signal received by signal receiver 605. Meanwhile, the main controller 610 performs the identification of button on background page 701 and reads the associated button information. When a preview-able button is pressed, the previewed audio/video data unit is played in the corresponding preview window. The method will be described in details in FIG. 8 and FIG. 9.

On the other hand, when the user press an “enter” button after pressing the movement button (up, down, left and right), an activation signal is issued. In this case, main controller 610 enters the activation mode according to the page control description data and the switching signal received by signal receiver 605. Meanwhile, the main controller 610 performs the identification of button on background page 701 and reads the associated button information. According to the associated button information, main controller 610 sends starting address 411b and ending address 411c of the selected original audio/video data unit to reading device 602 for reading the data in the unit. Then, multiplex, decode, transform into the appropriate format by main controller 610, and output to display 606 for display until the entire original audio/video data unit is processed.

FIG. 8 shows a flowchart of the preview on-demand method of the present invention.

Refer to FIGS. 4-8 for the following description. The preview on-demand method for digital audio/video data of the present invention is applicable to a medium reproducing system 600 having a signal receiver 605, an audio output device 609 and a display 606. The method starts with step 801, which is to divide, encode and store data in a recording medium 400. Recording medium 400 at least includes a preview audio/video data unit area 402, a background page area 403, and a page control descriptor area 404. Preview audio/video data unit area 402 includes a plurality of low-resolution preview audio/video data units 501. Background page area 403 includes high-resolution background page video data. Page control descriptor area 404 stores page control description data, which includes at least a number 401 of the buttons and a plurality of button information 4411-41N. Each button information 411-41N stores a starting address 411d of the preview audio/video data unit, preview window coordinates 411h and a preview window size 411i.

Step 802 is to read, de-multiplex, and decode the page control description data and background page, and output the decoded background page to display 606. Step 803 is to detect an input button signal and identify the corresponding button. Step 804 is to read, de-multiplex and decode the preview audio/video data unit according to starting address 411d of the preview audio/video data unit stored in the button information. And finally, step 805 is to preview the preview audio/video data unit.

Medium reproducing system 600 can be a personal computer or a DVD player, and recording medium 400 can be a CD, a flash card or a micro-drive. The video format of original audio/video data unit 503 can be ISO-defined MPEG, AVI, or WMV. The audio format of original audio/video data unit 503 and preview audio/video data unit 501 can be MP2, MP3, WAVE or WMA.

FIG. 9A is a flowchart of background initialization method. Step 901 is to read, de-multiplex and decode the page control description data and background page video data Step 902 is to set one of the buttons in the background page as the initial button. Step 903 is to read, de-multiplex and decode the preview audio/video data unit according to the starting address of the preview audio/video data unit of the button information. Finally, step 904 is to repeatedly play the preview audio/video data unit in the preview window corresponding to the button.

FIG. 9B is a flowchart of button identification method. Step 911 is to detect if a switch signal is received; if not, repeat this step until a signal is received and proceed to step 912. Step 912 is to identify the button. Step 913 is to check if the button is a preview-able mode; if not, skip to step 911; otherwise, proceed to step 914. Step 914 is to read the starting address and the ending address of the preview audio/video data unit, the preview window coordinates, and the preview window size.

FIG. 9C is a flowchart of previewing method of preview audio/video data unit. Step 921 is to overlap the decoded preview audio/video data unit onto the decoded background page video data at the location specified by the preview window coordinates and output to display 606. Meanwhile, the decoded audio data of the preview audio/video data unit is outputted to audio output device 609. Main controller 610 activates switch 608 so that the decoded preview video data and the background page can be overlapped by overlapper 607 and transformed by main controller 610 into an appropriate format for outputting to display 606.

Step 922 is to detect if a switch button signal is received; if so, return to step 912; otherwise, proceed to step 923. Step 923 is to read, de-multiplex and decode the next preview audio/video data unit. Finally, step 924 is to check if the ending address of the preview audio/video data unit is reached; if so, return to step 804; otherwise, return to step 921.

The present invention includes a preview mode before the activated mode. When the button is in the preview mode, the reproducing system uses the links stored on the recording medium to process the low-resolution preview audio/video unit data and high-resolution background page when receiving a switch button signal from the user. The composite image is output in real-time.

Furthermore, the current technique used for DVD previewing is to paste the data in each preview audio/video data unit packet to the background page to form a new film, which is then compressed and stored in the DVD. The compressed data requires a large storage space because it contains the background page video data. The present invention requires a smaller storage space because it only stores the data in the preview audio/video data unit packet.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for previewing digital audio/video data, to be used in a medium reproducing system having a signal receiver, an audio output device and a display; said method comprising the steps of:
(a) dividing, encoding and storing a data in a recording medium, so that said recording medium comprising at least a preview audio/video data unit area, a background page area, and a page control descriptor area; said preview audio/video data unit area comprising a plurality of preview audio/video data unit, said background page area storing background page video data, said background page area at least comprising a plurality of buttons, said page control descriptor area at least comprising a number of total buttons, and a plurality of button information areas; each button information area storing button information including at least a starting address of said preview audio/video data unit, preview window coordinates, and a preview window size;
(b) reading, de-multiplexing and decoding said page control descriptor and said background page video data, and outputting decoded said background page video data to said display;
(c) detecting an input switch button signal, and identifying corresponding button;
(d) reading, de-multiplexing and decoding said preview audio/video data unit according to said starting address of said preview audio/video data unit in said button information; and
(e) previewing said preview audio/video data unit.

2. The method as claimed in claim 1, the data structure of said recording medium further comprises an original audio/video data unit area, a preview audio/video data unit area, a background page area, and a page control descriptor area; said background page area at least comprises a plurality of buttons and said page control descriptor area stores at least a total number of said buttons and a plurality of button information; each button information area stores button information including at least an icon mode, a starting address of an original audio/video data unit, an ending address of an original audio/video data unit, a starting address of a preview audio/video data unit, an ending address of a preview audio/video data unit, button coordinates, a button size, previewing window coordinates, and a previewing window size.

3. The method as claimed in claim 2, wherein said step (b) further comprises the steps of:
(b1) reading, de-multiplexing and decoding said page control description data and said background page video data;
(b2) pre-setting one of said buttons of said background page as an initial button;
(b3) reading, de-multiplexing and decoding said preview audio/video data unit in accordance with said starting address of said preview audio/video data unit of said button information; and
(b4) repeatedly playing said preview audio/video data unit in said preview window corresponding to said button.

4. The method as claimed in claim 2, wherein said step (c) further comprises the steps of:
(c1) checking if a switch button signal being received; if not, repeating step (c1);
(c2) identifying said switch button signal;
(c3) checking if said button mode of said button information being preview-able; if not, returning to step (c1); and
(c4) reading said starting and ending addresses of said preview audio/video data unit, said preview window coordinates and said preview window size.

5. The method as claimed in claim 2, wherein said step (e) further comprises the steps of:
(e1) overlapping said video data of said decoded preview audio/video data unit onto said preview window at a location specified by said coordinates on said decoded background page video data, and outputting said overlapped video data to said display, while outputting said audio data of said decoded preview audio/video data unit to said audio output device;
(e2) checking if a switch button signal being received; if so, returning to step (c2);
(e3) reading, de-multiplexing and decoding a next preview audio/video data unit; and
(e4) determining if said ending address of said preview audio/video data unit being reached; if so, returning to step (d); otherwise, returning to step (e1).

6. The method as claimed in claim 1, wherein said medium reproducing system is a personal computer or a digital video disc player.

7. T he method as claimed in claim 1, wherein said recording medium is a compact disc, a flash card or a micro-drive.

8. The method as claimed in claim 1, wherein the video data format of said original audio/video data unit is ISO-defined MPEG, AVI, or WMV.

9. The method as claimed in claim 1, wherein the audio data format of original audio/video data unit and said preview audio/video data unit is MP2, MP3, WAVE or WMA.

10. A recording medium, for being used in a medium reproducing system to reproduce data stored on said recording medium, said recording medium comprising:
an original audio/video data unit packet, further comprising a plurality of original video data units and a plurality of original audio data units;
a preview audio/video data unit packet, further comprising a plurality of preview video data units and a plurality of preview audio data units, total data amount being about one-fifth of that of said original audio/video data unit packet;
a background page packet, for storing background page video data; and
a page control descriptor packet, further comprising at least a number of total buttons and a plurality of button information.

11. The recording medium as claimed in claim 10, wherein said button information at least comprises a button mode, a starting address of an original audio/video data unit, an ending address of an original audio/video data unit, a starting address of a preview audio/video data unit, an ending address of a preview audio/video data unit, button coordinates, a button size, previewing window coordinates, and a previewing window size.

12. The recording medium as claimed in claim 10, wherein said medium reproducing system is a personal computer or a digital video disc player.

13. The recording medium as claimed in claim 10, wherein said recording medium is a compact disc, a flash card or a micro drive.

14. The recording medium as claimed in claim 10, wherein the video data format of said original audio/video data unit is ISO-defined MPEG, AVI, or WMV.

15. The recording medium as claimed in claim 10, wherein the audio data format of original audio/video data unit and said preview audio/video data unit is MP2, MP3, WAVE or WMA.
